(19) United States
(12) Patent Application Publication
(10) Pub. No.: US 2002/0024229 A1
(43) Pub. Date: Feb. 28, 2002

(54) Child-vehicle pusher's raincover

(76) Inventors: Yinka Davies, Walthamstow (GB); Raymond Adewunmi, Aylesbury (GB)

Correspondence Address: RAYMOND ADEWUNMI, 2. ROBERTS DRIVE., AYLESBURY, HP19 9PP, GB

(21) Appl. No.: 09/736,699

(22) Filed: Mar. 13, 2001

(30) Foreign Application Priority Data
Aug. 25, 2000 (GB) GB0020888-4

(51) Int. Cl. B62B 9/00

(52) U.S. Cl. 296/77.1; 280/47.38; 296/97.21

(57) ABSTRACT

A childs vehicle pushers raincover which is detachable, adjustable and retractable this new product may be used on and adapted to other vehicles, such as prams and wheelchairs for the disabled. This new product comprises of two main parts. Namely the raincover (Nos 1 & 2) which will shelter the pusher from the rain/snow, and its two supporting adjustable poles (No 4 & 5). When the raincover is in operation (FIG. 1) it will be kept in the deired position of the user by two dual functioning clamps (No 3) which when loosened will prepare the raincover for storage if the telescopic adjustable poles are rotated forward to the point of rest on the main frame of the carriage, these clamps will both allow the raincover to be turned arc side up, and further permit, and further permit movement of the raincover up along telescopic poles to allow the headroom for the child (FIG. 2) the adjustable telescopic poles supporting the raincover are attach to the carriage by dual complete detachment of product from carriage and angled mevement, both backward and forward around the point of fixing.

The product has been designed both easy and convenient use. It would be no more an abstacle than the carriage itself, the primary aim of bringing a degree of comfort to the pusher in adverse weather conditions.

This new invention relates to a detachable, adjustable and retractable raincover.

Traditional raincovers in this field have been for the protection of children in pushed vehicles, renging from prams to pushchairs. This raincover is different in that its main purpose will be to provide protection for the person who will be pushing the vehicle.

This new procduct is designed to aid and improve the ease with which a person can push a child—carrying vehicle, in the time of rain and or snow, both hands will be free to steer the vehicle with the upmost saftey, as compared to pushing it with one hand, whilst holding an umbrella with the other hand.

According this present invention there is provided a detachable, adjustable and retractable child—pusher's raincover, which has two supporting telescopic poles that extend out of and retract within themselves, to allow the user to determine the height of the raincover.

A simple definition will now be given to the main features of the child—vehicle pusher's raincover.

By detachable, is meant that the raincover can be completely dismantled form the child's pushchair, if the user anticipates for example no rain. In this case, the user can unfasten two dual functioning universal clamps which will release the product from the vehicle.

By adjustable is meant that the raincover can be set to different heights, as per the user, and it is the abilty to do this which forms the ‘essential technical features’ of this invention. There are two supporting telescopc poles which can extend out of and retract within themselves and then set to stay in place as required.

By retractable is meant two possible ‘fold away’ positions in which the raincover may be placed. The first is ‘forward retractable’ position where the raincover can be pushed forward using the telescopic poles, to rest on the front of the pushchair above the childs head. The second is a ‘backward retractable’ position where the raincover can be pulled back (reclinning motion) and closed in a position where it will securely hang upside down, behind the pushchair.

The raincover is supported by two telescopic poles which have a dual functioning universal clamps for general attachment to any child carrying vehicle.

By ‘dual functioning universal clamps’ is meant a device which whilst generally the securing the entire invention to a childs carriage will at the same time allow movement of position from the front retratable, through to the main upright and further to back retractable positions, as required.

To differentiate, there are also two ‘dual functioning clamps’ separate from the dual functioning universal clamps which serve to both secure the waterproof cover in various positions to the top ends of telescopic poles, whilst also allowing movement along the length of the poles.

### A SPECIFIC EMBODIMENT OF THE INVENTION WILL NOW BE DESCRIBED BY THE WAY OF EXAMPLE TO ACCOMPANYING DRAWINGS.

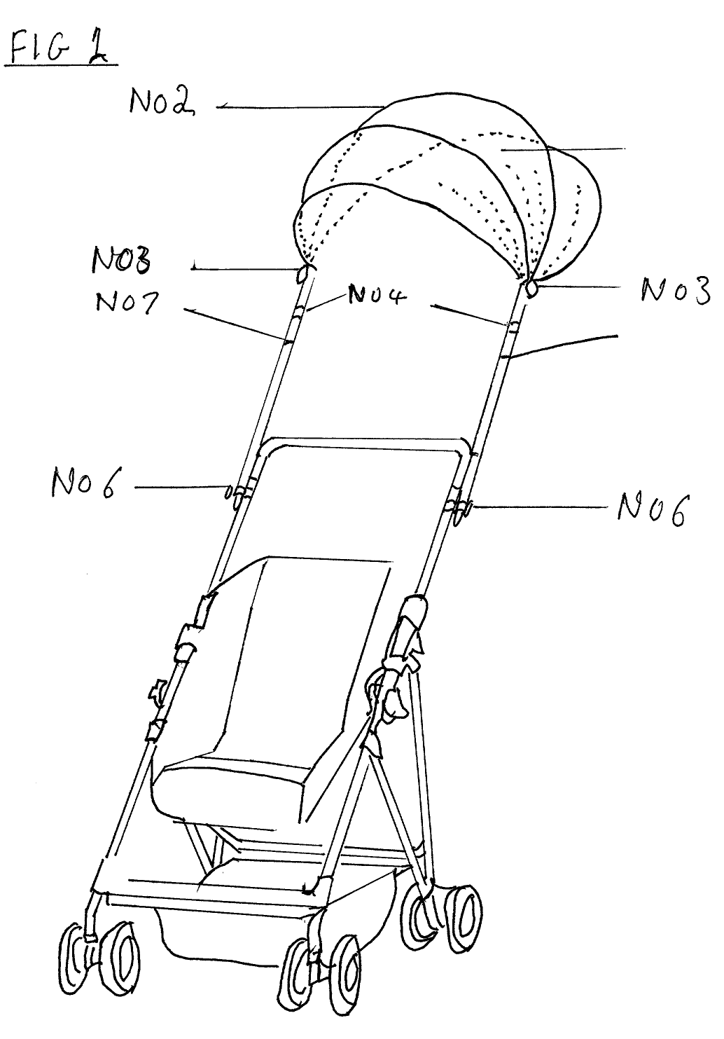

FIG. 1 refers to the new invention in its functional position the raincover is fully supported by two adjustable, telescopic (plastic) poles. The angle of this invention in its functional state will be determined by such factors, as angle of rainfall or ground, and preference of user. The two adjustable and telescopic poses will each attached to the vehicle (childs) by dual functioning, universal clamps their purpose will be to allow the secure fastening of this invention to the vehicle whilst independently allowing the invention adjust through all angles/postions, from the two fold-away positions to the functional upright position. This example shows a pushchair, but the same invention may be applied to other vehicles such as prams.

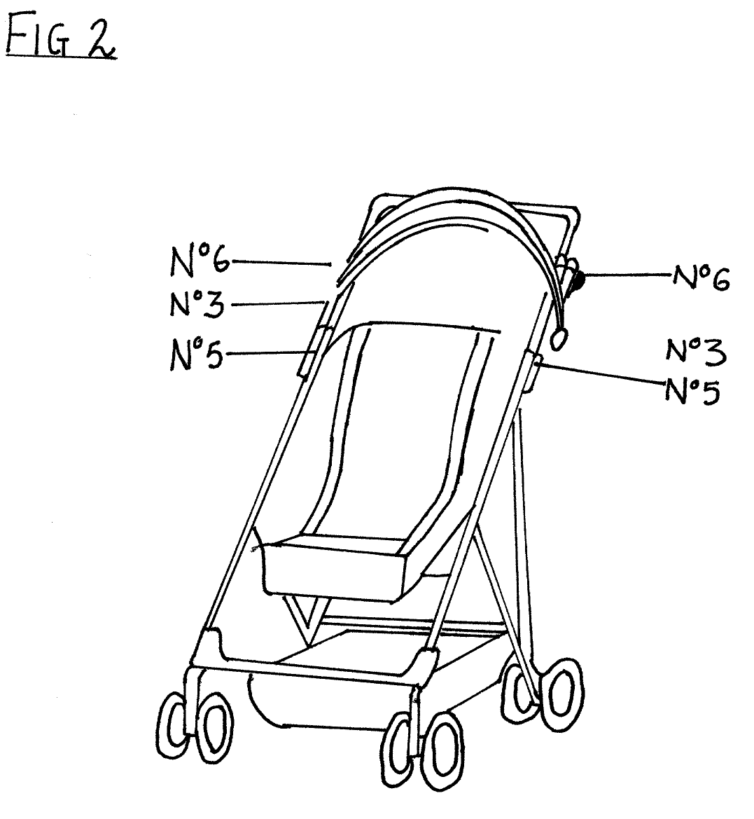

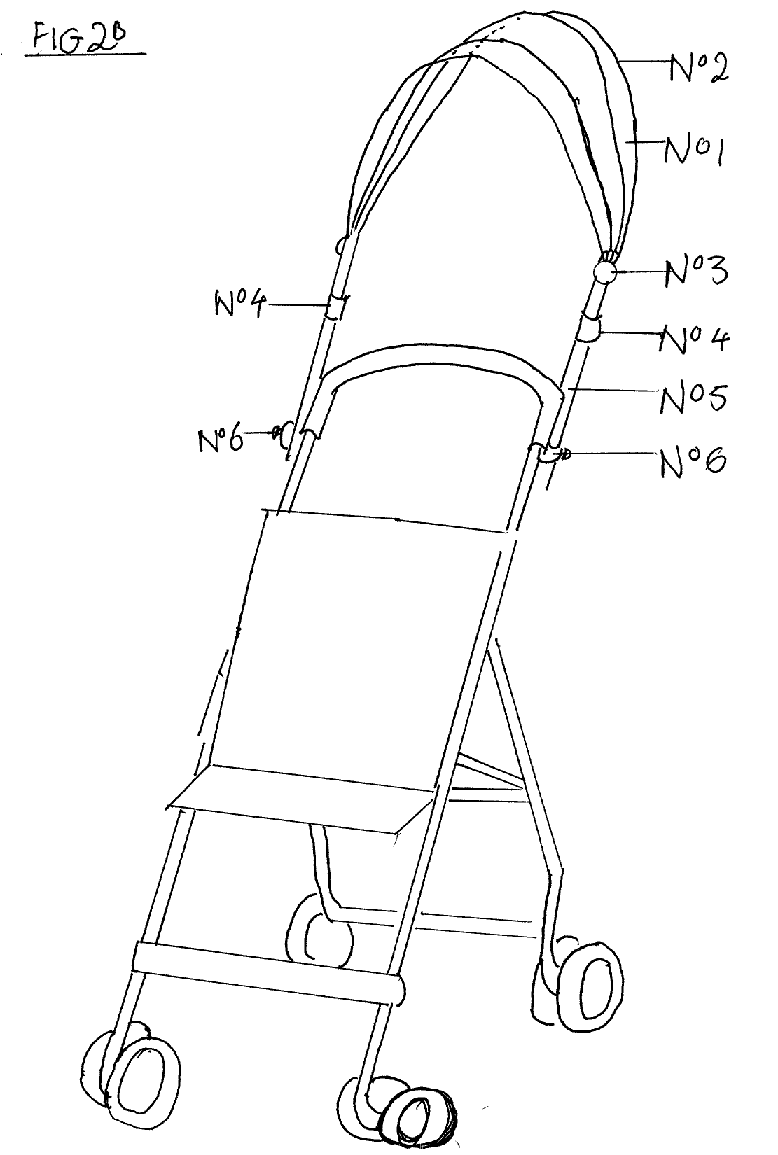

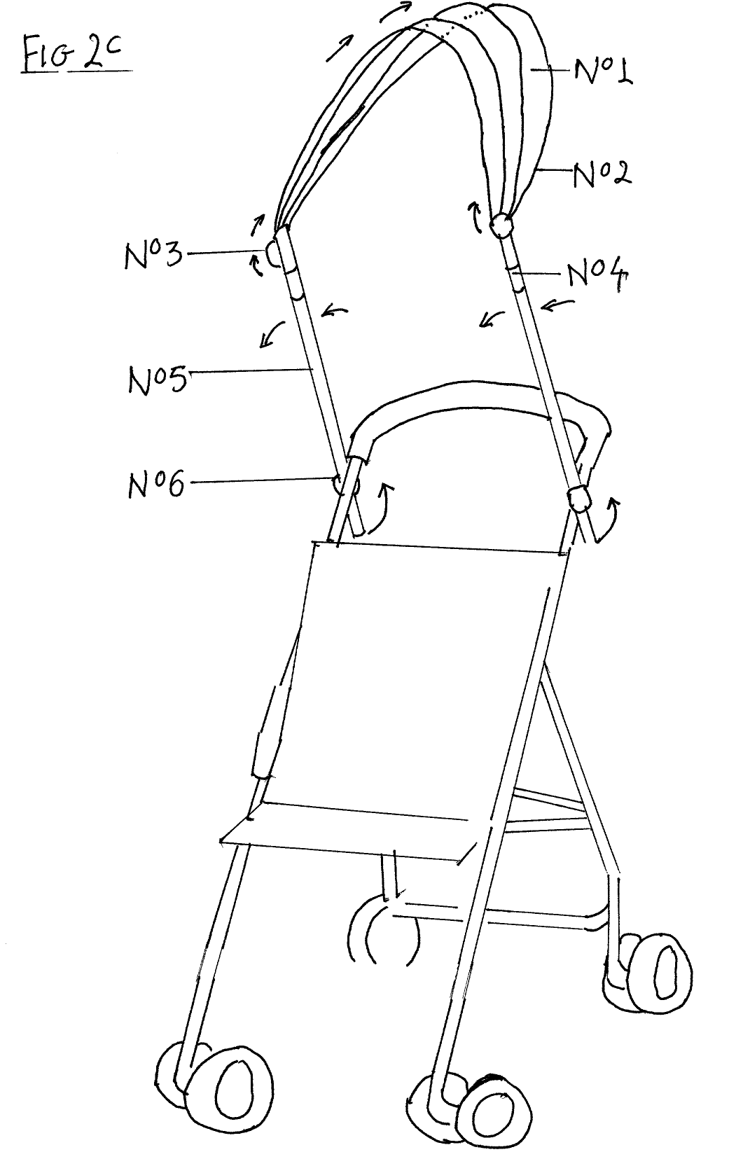

FIG. 2 this demonstrates the new invention in the first of two retractable (fold away) positions. This is known as the front retractable position. The raincover will arc-up above the seat of the childs pushed vehicle. This position is adjustable to allow for the childs headroom. The supporting adjustable telescopic poles will manoeuvre in such a way to allow attachment to the childs carriage in two places. Firstly by the universal clamps which are consistently located around the carriage handle area. Secondly by attachment clips which will fasten the topp End of the two plastec telescopic poles to the main frame of The carriage.

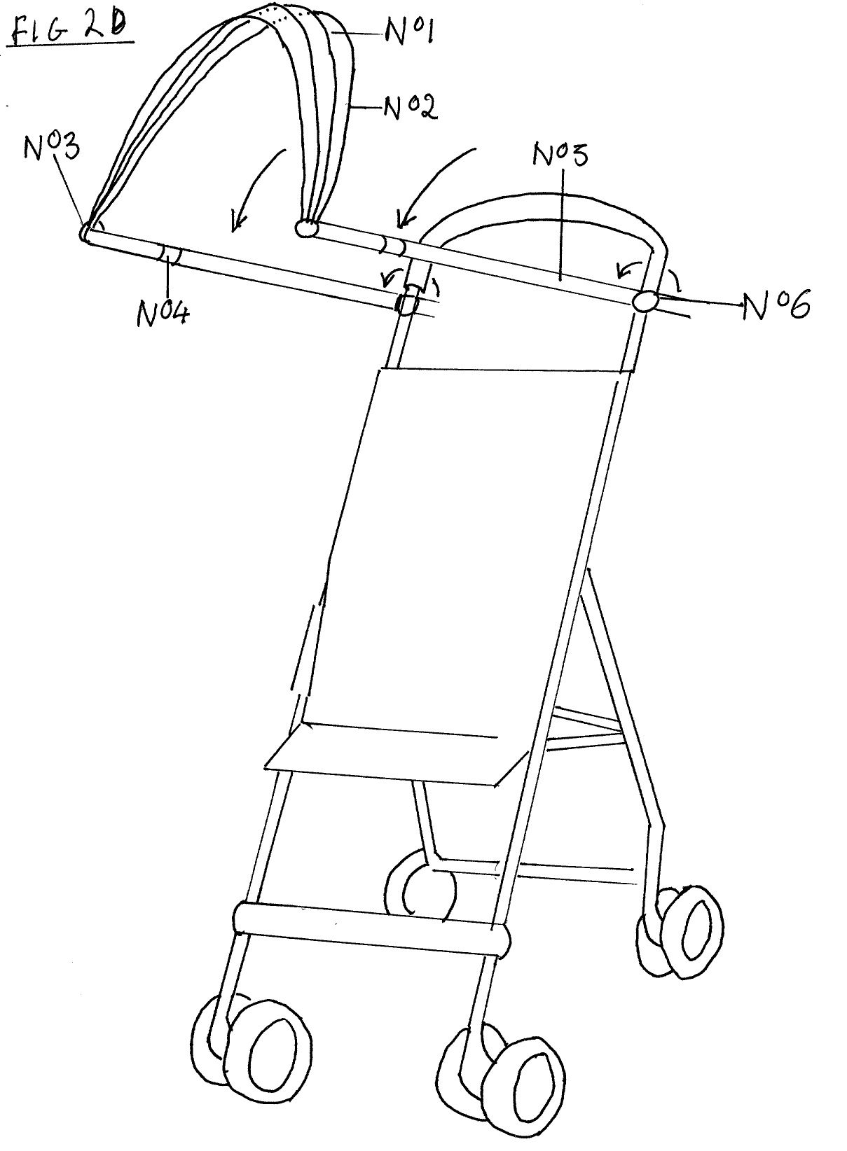

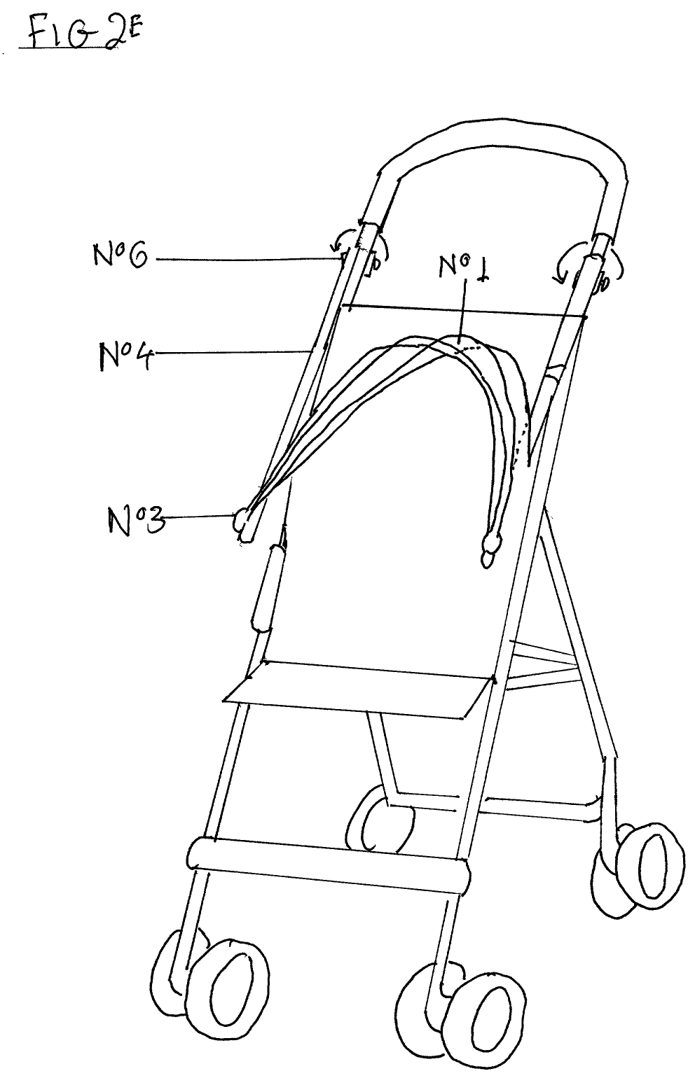

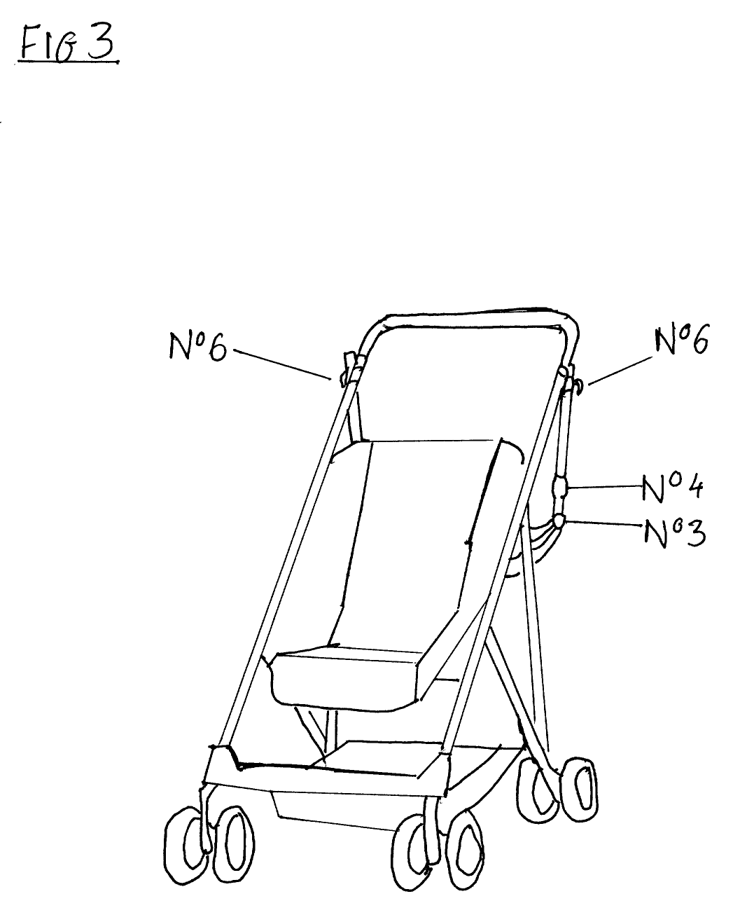

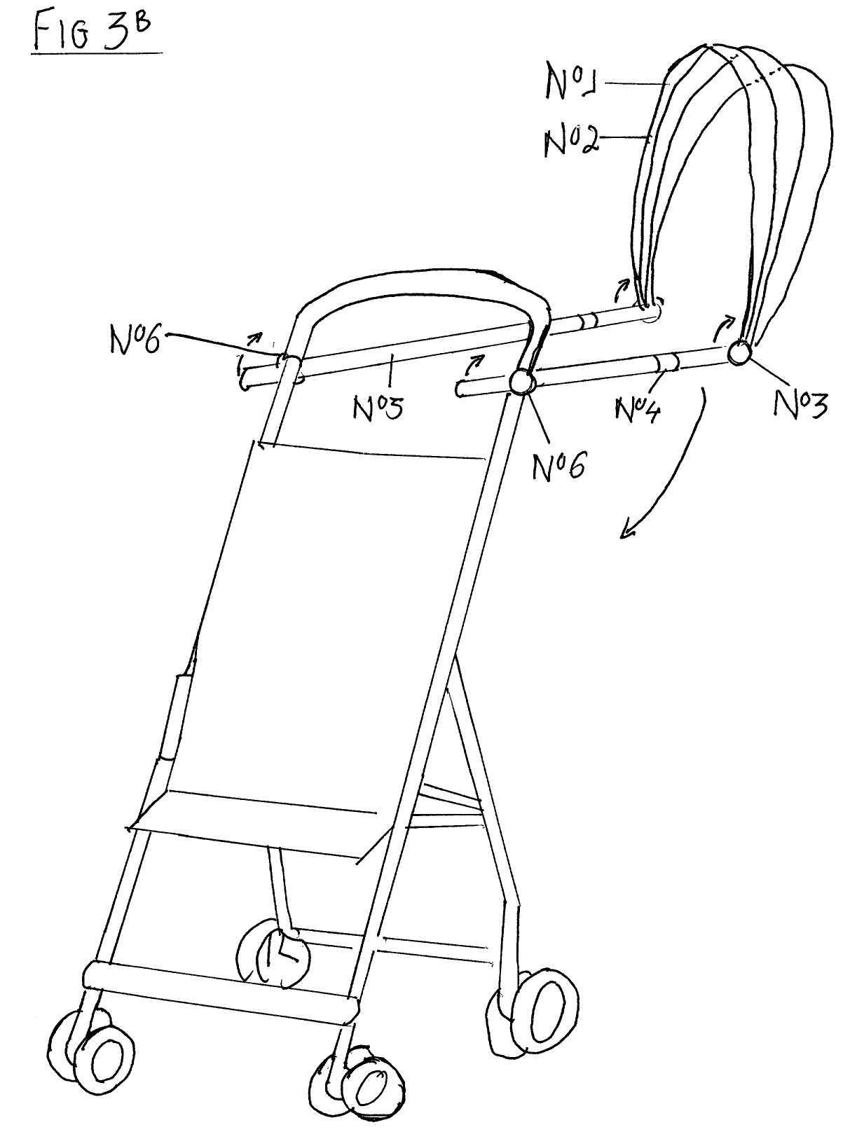

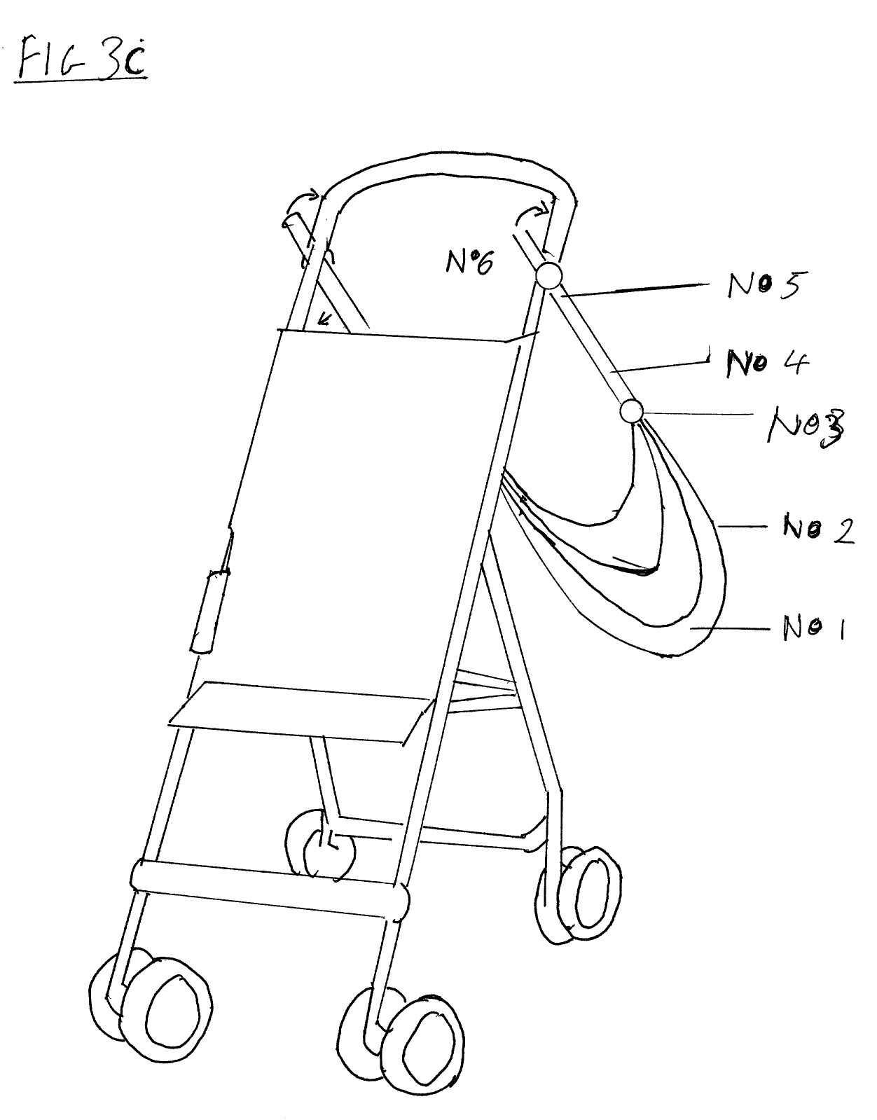

FIG. 3 this demonstrates the new invention in the second of the two retractable (fold away) positions here from the vertical position the universal clamps will be loosened to allow the telescope poles to be rotated back in there shortest position they will hang down, secured in place by the tightening thereafter of the universal clamps. The raincover itself will be in the position of non-intrusive.

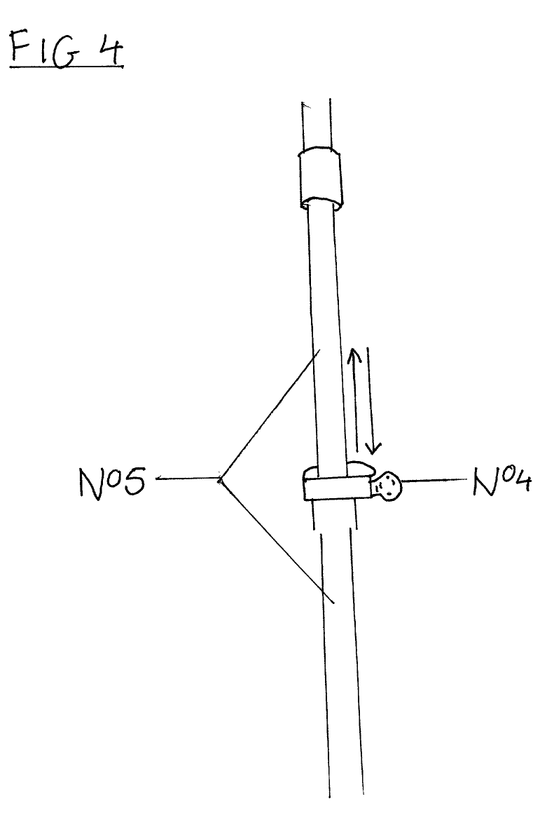

FIG. 4 this is a simple demonstration of the function of the telescopic poles which support the raincover adjustment of telescopic poles will allow them to be better extended or shortened to meet the height requirement of the user.

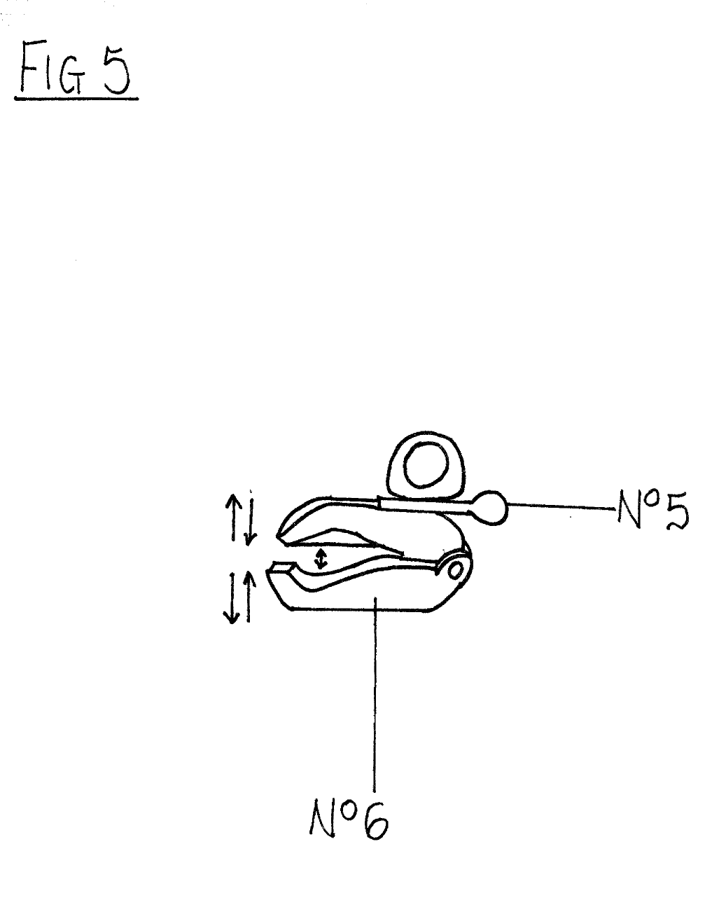

FIG. 5 shows ‘birds eye view’ of the universal clamps incorporated in this mechanism is a dual functioning device. They allow the independent adjustment of both the clamps to the handles of the carriage and telescopic poles to the clamps.

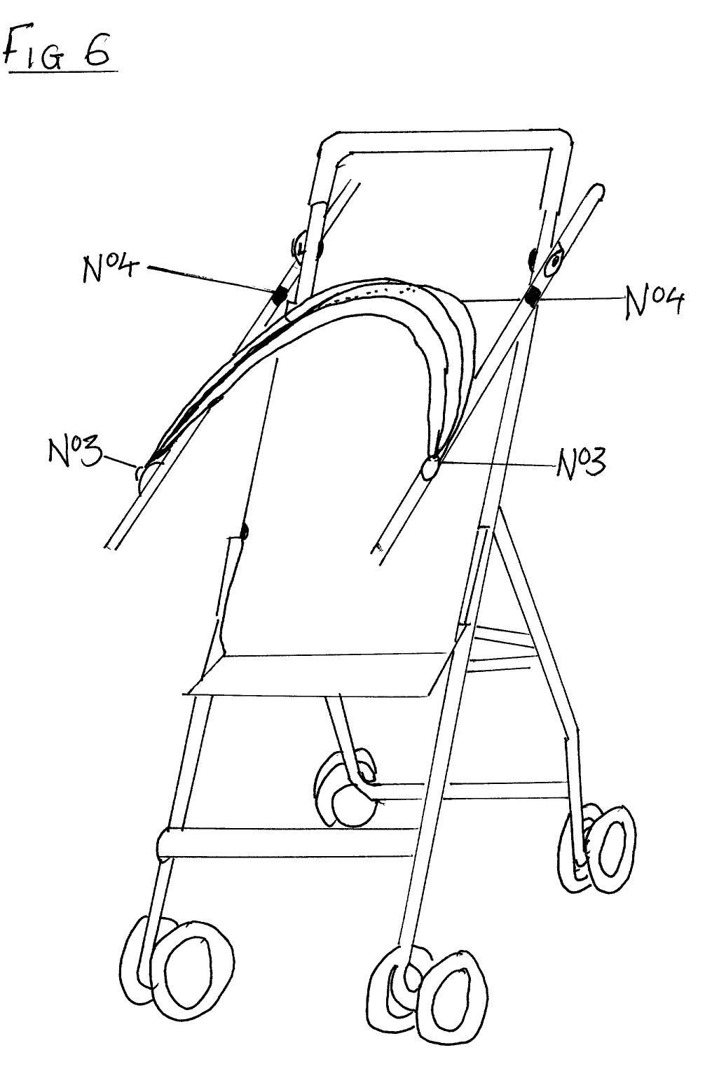

FIG. 6 this demonstrates the operational movement of the dual functioning clamping component along the length of the adjustable telescopic poles, and will be taken into account, head height of child.

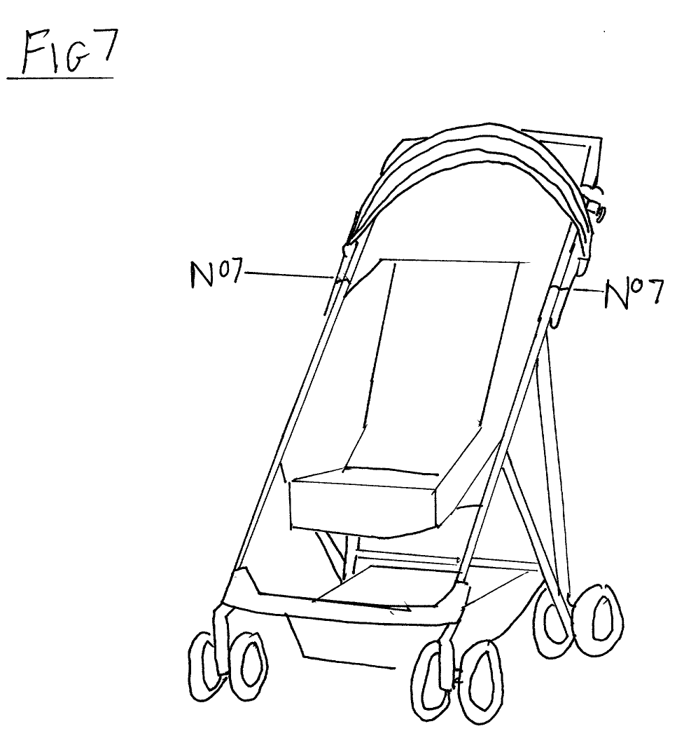

FIG. 7 demonstrates the position of the elasticated clips which will function to attachthe adjustable telescopic poles to the main frame of the carriage, providing additional support whilst in storage positions, both front and back.

referring to the drawings the raincover comprises two main parts, namely the raincover (No. 1 & 2) and its two supporting adjustable poles (No. 4 & 5). When the raincover is in operation, it will be kept in the desired position (FIG. 1) of the user by the user by two dual functioning clamps (No. 3) which when loosened will prepare the raincover for storage(FIG. 2 & 3). If the telescopic adjustable poles (NO. 4 & 5) are rotated forward to the point of rest on the main frame of the carriage these clamps (No. 3) will both allow the raincover to be turned back sidiup (No. 2) and further permit movement of the raincover, up along the telescopic poles to allow headroom for the child (FIG. 5). The adjustable telescopic poles (No. 4 & 5) supporting the raincover attach to the carriage by dual functionining universal clamps (No. 6) which permit both complete detachment of porducts from carriage and angled movement both forward and backward around the point of fixing there will be elasticated clips (FIG. 7, No. 7) which both provide additional support whilst in storage.

1. a detachable, adjustable and retractable child vehicle pushers raincover which has two supporting telescopic poles that extend out of and retracts within themselves, to allow the user to determine the required height of the raincover.

2. a detachable, adjustable and retractable child vehicle pushers raincover which has two supporting telescopic poles as claimed in claim 1, each with tightening devices to secure the height desired by the user.

3. a detachable, adjustable and retractable child vehicle pushers raincover which has two supporting telescopic poles as claimed in claim 1 & 2, each attachable to the frame of the childs vehicle at their bottom ends.

4. a detachable, adjustable and retractable child vehicle pushers raincover, which has two supporting telescoping poles as claimed in claim 3 each attachable at eheir top ends to the raincover.

5. a detachable, adjustable and retractable child's vehicle pushers raincover, substantially as desired herein with reference to the accompanying drawings.
